(19) United States
(12) Patent Application Publication
(10) Pub. No.: US 2014/0086223 A1
(43) Pub. Date: Mar. 27, 2014

(54) METHOD FOR BASE STATION PROVIDING PERIODIC CHANNEL STATE REPORT, AND METHOD FOR USER EQUIPMENT PROVIDING PERIODIC CHANNEL STATE REPORT

(71) Applicants: Donghyun Park, Seoul (KR); Kyoungmin Park, Seoul (KR)

(72) Inventors: Donghyun Park, Seoul (KR); Kyoungmin Park, Seoul (KR)

(73) Assignee: Pantech Co., Ltd., Seoul (KR)

(21) Appl. No.: 14/115,066

(22) PCT Filed: May 2, 2012
(86) PCT No.: PCT/KR2012/003436

§ 371 Date: Oct. 31, 2013

(30) Foreign Application Priority Data
May 3, 2011 (KR) 10-2011-0042185
May 2, 2012 (KR) 10-2012-0046071

(51) Int. Cl. H04L 5/00

(52) U.S. Cl. CPC H04L 5/0057
USPC 370/336; 370/329

(57) ABSTRACT

The present invention relates to a communication system, and more particularly, to a periodic channel state report in a communication system.

### CROSS-REFERENCE TO RELATED APPLICATIONS

This application is the National Stage Entry of International Application PCT/KR2012/003436, filed on May 2, 2012, and claims priority from and the benefit of Korean Patent Application No. 10-2011-0042185, filed on May 3, 2011 and Korean Patent Application No. 10-2012-0046071, filed on May 2, 2012, all of which are incorporated herein by reference in their entireties for all purposes as if fully set forth herein.

### BACKGROUND

1. Field

The present invention relates to a communication system, and more particularly, to a periodic channel state report in a communication system.

2. Discussion of the Background

In a communication system, downlink channel-dependent scheduling which selects downlink transmission setting and related parameters based on a state of a downlink channel is a main function in downlink. A channel state report that a user equipment provides to a base station plays an important role in helping the downlink channel-dependent scheduling. The base station determines scheduling based on the channel state report.

The channel state report may be provided periodically or aperiodically by the user equipment. Typically, the channel state report is transmitted through an uplink control channel.

### SUMMARY

Therefore, an aspect of the present invention is to provide a method for providing a periodic channel state report appropriate for a heterogeneous network and a method for providing a user equipment with information required for a periodic channel state report.

In accordance with an aspect of the present invention, there is provided a method for providing a setting of a periodic channel state report by a base station. The method includes: setting multiple transmission points that are to transmit downlink data to a user equipment; generating multiple parameters determining a period and an offset for a periodic channel state report on each of the multiple transmission points; and transmitting the multiple parameters to the user equipment, wherein the multiple parameters include: a parameter determining a period and an offset for a Channel Quality Indicator/Precoding Matrix Indicator (CQI/PMI) report; and a parameter determining a period and an offset for a Rank Indication (RI) report.

In accordance with another aspect of the present invention, there is provided a method for providing a setting of a periodic channel state report by a base station. The method includes: setting multiple transmission points that are to transmit downlink data to a user equipment and one or more component carriers, through which downlink data is to be transmitted by each of the multiple transmission points; generating multiple parameters determining periods and offsets for periodic channel state reports on the one or more component carriers, by the multiple transmission points; and transmitting the multiple parameters to the user equipment, wherein the multiple parameters include: a parameter determining a period and an offset for a Channel Quality Indicator/Precoding Matrix Indicator (CQI/PMI) report; and a parameter determining a period and an offset for a Rank Indication (RI) report.

In accordance with another aspect of the present invention, there is provided a method for providing a periodic channel state report by a user equipment. The method includes: extracting multiple parameters determining a period and an offset for a periodic channel state report on each of multiple transmission points from a received downlink signal; setting a transmission time period, during which the periodic channel state report on each of the multiple transmission points is to be transmitted, by using the multiple parameters; and transmitting a periodic channel state report on a transmission point matched to the transmission time period through a Physical Uplink Control Channel (PUCCH), wherein the multiple parameters include: a parameter determining a period and an offset for a Channel Quality Indicator/Precoding Matrix is Indicator (CQI/PMI) report; and a parameter determining a period and an offset for a Rank Indication (RI) report.

In accordance with another aspect of the present invention, there is provided a method for providing a periodic channel state report by a user equipment. The method includes: extracting multiple parameters determining periods and offsets for periodic channel state reports on one or more component carriers of multiple transmission points, from a received downlink signal; setting a transmission time period, during which the periodic channel state reports on the one or more component carriers of the multiple transmission points are to be transmitted, by using the multiple parameters; and transmitting a periodic channel state report on a component carrier of a transmission point matched to the transmission time period through a Physical Uplink Control Channel (PUCCH), wherein the multiple parameters include: a parameter determining a period and an offset for a Channel Quality Indicator/Precoding Matrix Indicator (CQI/PMI) report; and a parameter determining a period and an offset for a Rank Indication (RI) report.

In accordance with another aspect of the present invention, there is provided a user equipment. The user equipment includes: a parameter extractor for extracting multiple parameters determining a period and an offset for a periodic channel state report on each of multiple transmission points, from a received downlink signal; a channel state report transmission setter for setting a transmission time period, during which the periodic channel state report on each of the multiple transmission points is to be transmitted, by using the multiple is parameters; and an uplink transmitter for transmitting a periodic channel state report on a transmission point matched to the transmission time period through a Physical Uplink Control Channel (PUCCH).

In accordance with another aspect of the present invention, there is provided a user equipment. The user equipment includes: a parameter extractor for extracting multiple parameters determining periods and offsets for periodic channel state reports on one or more component carriers of multiple transmission points, from a received downlink signal; a channel state report transmission setter for setting a transmission time period, during which the periodic channel state reports on the one or more component carriers of the multiple transmission points are to be transmitted, by using the multiple parameters; and an uplink transmitter for transmitting a periodic channel state report on a component carrier of a transmission point matched to the transmission time period through a Physical Uplink Control Channel (PUCCH).

### BRIEF DESCRIPTION OF DRAWINGS

FIG. 1 is a block diagram illustrating an example of a communication system;

FIG. 2 is a signal flow diagram illustrating an example of a method for reporting a channel state in the communication system illustrated in FIG. 1;

FIG. 3 is a block diagram illustrating an example of a system, to which is exemplary embodiments of the present invention can be applied;

FIG. 4 is a signal flow diagram illustrating an example of a method for reporting a channel state in the communication system illustrated in FIG. 3;

FIG. 5 is a block diagram illustrating a configuration of an apparatus for periodic channel state report setting transmission according to an embodiment of the present invention;

FIG. 6 is a flowchart illustrating a method for providing a setting by the apparatus for the periodic channel state report setting transmission as illustrated in FIG. 5, according to an embodiment of the present invention;

FIG. 7 is a block diagram illustrating a configuration of an apparatus for a periodic channel state report according to an embodiment of the present invention;

FIG. 8 is a flowchart illustrating a method for reporting a channel state by the apparatus for the periodic channel state report as illustrated in FIG. 7, according to an embodiment of the present invention;

FIG. 9 is a view illustrating an example of a periodic channel state report transmitted by the apparatus for the periodic channel state report as illustrated in FIG. 7;

FIG. 10 illustrates an example of a case in which two periodic channel state reports overlap in one uplink subframe;

FIG. 11 is a flowchart illustrating a method for periodically reporting a channel state by the apparatus for the channel state report as illustrated in FIG. 7, according to another embodiment of the present invention; and

FIG. 12 is a flowchart illustrating a method for periodically reporting a channel is state by the apparatus for the channel state report as illustrated in FIG. 7, according to still another embodiment of the present invention.

### DETAILED DESCRIPTION OF THE ILLUSTRATED EMBODIMENTS

Hereinafter, exemplary embodiments of the present invention will be described in detail with reference to the accompanying drawings. It should be noted that in assigning reference numerals to elements in the drawings, the same elements will be designated by the same reference numerals although they are shown in different drawings. Further, in the following description of the present invention, a detailed description of known functions and configurations incorporated herein will be omitted when it may make the subject matter of the present invention rather unclear.

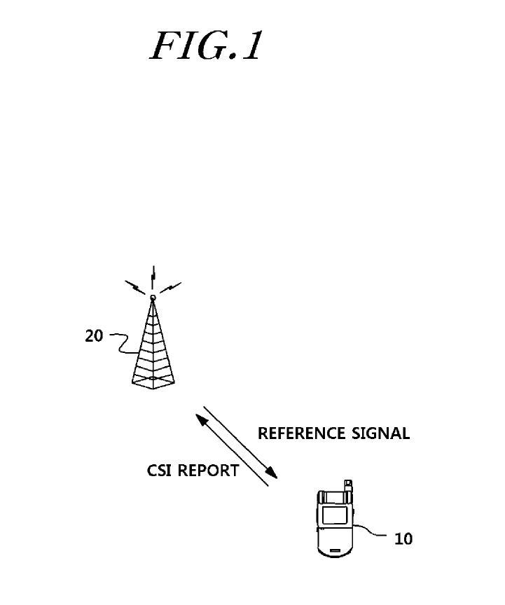

FIG. 1 illustrates an example of a communication system.

The communication system is widely arranged in order to provide various communication services, such as voice, packet data, and the like.

Referring to FIG. 1, the communication system includes a User Equipment (UE) 10 and a Base Station (BS) 20.

In this specification, the UE 10 has a comprehensive concept implying a user terminal in wireless communication. Accordingly, the UEs should be interpreted as having the concept of including a Mobile Station (MS), a User Terminal (UT), a Subscriber Station (SS), a wireless device, and the like in Global System for Mobile Communications (GSM) as well as is User Equipments (UEs) in Wideband Code Division Multiple Access (WCDMA), Long Term Evolution (LTE), High Speed Packet Access (HSPA), and the like.

The BS 20 or a cell usually refers to a station communicating with the UE 10, and may be called different terms, such as a Node-B, an evolved Node-B (eNB), a Base Transceiver System (BTS), an Access Point (AP), a relay node, and the like.

There is no limit to multiple access schemes applied to the communication system. Exemplary embodiments of the present invention may use various multiple access schemes, such as Code Division Multiple Access (CDMA), Time Division Multiple Access (TDMA), Frequency Division Multiple Access (FDMA), Orthogonal Frequency Division Multiple Access (OFDMA), OFDM (Orthogonal Frequency Division Multiplexing)-FDMA, OFDM-TDMA, and OFDM-CDMA.

Also, embodiments of the present invention may use a Time Division Duplex (TDD) scheme in which uplink transmission and downlink transmission are performed at different times. Otherwise, embodiments of the present invention may use a Frequency Division to Duplex (FDD) scheme in which uplink transmission and downlink transmission are performed by using different frequencies. Otherwise, embodiments of the present invention may use a Hybrid Duplexing scheme in the form of combining the two schemes.

Specifically, exemplary embodiments of the present invention can be applied to the field of asynchronous wireless communications which have gone through GSM, WCDMA and HSPA, and evolve into LTE and LTE-advanced, the field of synchronous wireless communications which evolve into CDMA, CDMA-2000 and UMB, and the like. In this respect, the present invention should not be interpreted as being limited to or restricted by a particular wireless communication field, but should be interpreted as including all technical fields to which the spirit of the present invention can be applied.

Referring again to FIG. 1, the UE 10 and the BS 20 can communicate with each other in uplink and downlink directions.

The BS 20 transmits data to the UE 10 in downlink. The BS 20 transmits data through a downlink data channel (e.g., a Physical Downlink Shared Channel (PDSCH)) which is a main physical channel for unicast transmission. Then, the BS 20 transmits control information through a downlink control channel (e.g., a Physical Downlink Control Channel (PDCCH)) for transmitting downlink control information such as scheduling required to receive a PDSCH and the like, and scheduling grant information for transmission through an uplink data channel (e.g., a Physical Uplink Shared Channel (PUSCH)).

The UE 10 transmits an uplink signal to the BS 20. The UE 10 transmits control information or data information through a PUSCH which is a main physical channel for unicast transmission. Then, the UE 10 transmits control information through an uplink control channel (e.g., a Physical Uplink Control Channel (PUCCH)) which is a channel used to transmit Uplink Control Information (UCI), which includes HARQ acknowledgement notifying of whether a downlink transmission block has been successfully received; a channel state report; and a scheduling request requiring resource allocation when data is intended to be transmitted in uplink.

Hereinafter, a situation in which signals are transmitted and received through a channel, such as a PDCCH, a PDSCH, a PUCCH or a PUSCH, will be described as the transmission and reception of a PDCCH, a PDSCH, a PUCCH or a PUSCH.

Downlink channel-dependent scheduling which selects downlink transmission setting and related parameters based on a state of a downlink channel, is a main function in downlink. A channel state report that the UE 10 provides to the BS 20 plays an important role in helping the downlink channel-dependent scheduling. The BS 20 determines scheduling based on the channel state report.

The channel state report may include one or more pieces of Channel State Information (CSI) among the following multiple pieces of CSI.

(1) A Rank Indication (RI): the RI provides a rank of a channel (i.e., information on the number of layers desired to be used in downlink transmission to a relevant UE). The RI has a value of 1 to 8.

(2) A Precoder Matrix Indicator (PMI): the PMI provides information on a precoder matrix desired to be used in downlink transmission. A reported precoder matrix is determined based on the number of layers which is known by the RI. In the case of 2 and 4 is antenna ports, each PMI corresponds to a codebook index. In the case of 8 antenna ports, a PMI corresponds to a pair of codebook indices.

(3) A Channel-Quality Indicator (CQI): the CQI indicates a modulation scheme and a coding rate which are desired to be used in downlink transmission. The CQI indicates a particular combination in a table including combinations of a predetermined modulation scheme and a coding rate. For example, the CQI which has a value of 0 to 15 expressed in 4 bits indicates a modulation scheme, such as Quadrature Phase Shift Keying (QPSK), 16 Quadrature Amplitude Modulation (16QAM), 64QAM or the like, and a relevant coding rate.

According to a setting, different combinations of an RI, a PMI and a CQI configure a channel state report.

The channel state report may be aperiodic or periodic.

An aperiodic (or trigger-based) channel state report is transmitted from the UE 10 to the BS 20 when the BS 20 makes an explicit request. The BS 20 makes a request by using a channel state request flag included in an uplink scheduling grant using a Downlink Control Information (DCI) format 0. An aperiodic channel state report can be transmitted through a PUSCH.

A periodic channel state report can be set by the BS 20 so as to be transmitted in a particular period. It is not necessary to report all different types of information in an identical period. Typically, an RI may be reported in a longer period than a PMI and than a CQI. This is is because the number of layers which is appropriate for transmission, typically changes more slowly than the change of a channel which affects the selection of a precoder matrix and the selection of a modulation scheme and a coding rate.

Typically, the periodic channel state report is transmitted through a PUCCH. When the UE 10 has a valid uplink scheduling grant, a channel state report may be transmitted through a PUSCH.

For example, the following periodic channel state report types having different periods and offsets are provided for a report through a PUCCH.
A type 1 report provides Channel Quality Indicator (CQI) feedback for the UE selected subbands.
A type 1a report provides a subband CQI and the second Precoding Matrix Indicator (PMI) feedback.
A type 2 report, a type 2b report and a type 2c report provide wideband CQI and PMI feedback.
A type 2a report provides wideband PMI feedback.
A type 3 report provides RI feedback.
A type 4 report provides a wideband CQI.
A type 5 report provides RI and wideband PMI feedback.
A type 6 report provides an RI and a Precoder Type Indication (PTI).

A period N_{pd} and an offset N_{OFFSET,CQI} for a CQI/PMI report are determined based on a parameter I_{CQI/PMI} shown in Table 1 below. In Table 1 below, the period N_{pd} and the offset N_{OFFSET,CQI} are both expressed in a unit of subframe. The parameter I_{CQI/PMI} may be 10-bit value from 0 to 1023. A wideband CQI/PMI report has a period of H·N_{pd} and H is defined by H=J·K+1. A CQI report on a J number of subbands is repeated K times between wideband CQI/PMI reports.

TABLE 1

| I_{CQI/PMI} | Value of N_{pd} | Value of N_{OFFSET,CQI} |
|---|---|---|
| 0 ≦ I_{CQI/PMI} ≦ 1 | 2 | I_{CQI/PMI} |
| 2 ≦ I_{CQI/PMI} ≦ 6 | 5 | I_{CQI/PMI}-2 |
| 7 ≦ I_{CQI/PMI} ≦ 16 | 10 | I_{CQI/PMI}-7 |
| 17 ≦ I_{CQI/PMI} ≦ 36 | 20 | I_{CQI/PMI}-17 |
| 37 ≦ I_{CQI/PMI} ≦ 76 | 40 | I_{CQI/PMI}-37 |
| 77 ≦ I_{CQI/PMI} ≦ 156 | 80 | I_{CQI/PMI}-77 |
| 157 ≦ I_{CQI/PMI} ≦ 316 | 160 | I_{CQI/PMI}-157 |

| | |
|---|---|
| I_{CQI/PMI} = 317 | Reserved |

| | | |
|---|---|---|
| 318 ≦ I_{CQI/PMI} ≦ 349 | 32 | I_{CQI/PMI}-318 |
| 350 ≦ I_{CQI/PMI} ≦ 413 | 64 | I_{CQI/PMI}-350 |
| 414 ≦ I_{CQI/PMI} ≦ 541 | 128 | I_{CQI/PMI}-414 |

| | |
|---|---|
| 542 ≦ I_{CQI/PMI} ≦ 1023 | Reserved |

A relative period M_{RI} and a relative offset N_{OFFSET,RI} for an RI report are determined based on a parameter I_{RI} shown in Table 2 below. In Table 2 below, the offset N_{OFFSET,RI} is expressed in a unit of subframe. An interval between consecutive RI reports is determined as a value obtained by multiplying the wideband CQI/PMI period H·N_{pd} by M_{RI}. An RI is reported by using a shifted resource in a PUCCH period identical to each of periods of a wideband CQI/PMI report and a subband CQI report. The parameter I_{RI} may be 10-bit value from 0 to 1023.

TABLE 2

| I_{RI} | Value of M_{RI} | Value of N_{OFFSET,RI} |
|---|---|---|
| 0 ≦ I_{RI} ≦ 160 | 1 | —I_{RI} |
| 161 ≦ I_{RI} ≦ 321 | 2 | —(I_{RI}-161) |
| 322 ≦ I_{RI} ≦ 482 | 4 | —(I_{RI}-322) |
| 483 ≦ I_{RI} ≦ 643 | 8 | —(I_{RI}-483) |
| 644 ≦ I_{RI} ≦ 804 | 16 | —(I_{RI}-644) |
| 805 ≦ I_{RI} ≦ 965 | 32 | —(I_{RI}-805) |

| | |
|---|---|
| 966 ≦ I_{RI} ≦ 1023 | Reserved |

Meanwhile, in downlink, CSI is detected by using a reference signal that the BS 20 transmits to the UE 10.

For example, in an LTE system, a Cell-Specific Reference Signal (CRS) (or referred to as a “Common Reference Signal”) can be used for the measurement of a state of a downlink channel and for the estimation of a downlink channel which is used to demodulate the downlink physical channel. A CRS is common in all of the UEs which communicate with the BS.

A CRS is transmitted in each downlink subframe, and may be transmitted over an entire bandwidth of a downlink cell. The CRS may be transmitted through one or more of antenna ports 0 to 3. One CRS is transmitted through each downlink antenna port. A Resource Element (RE) used to transmit one CRS through one port from among the antenna ports within a slot cannot be used for another antenna port within the same slot.

Meanwhile, in the next generation communication technologies, the BS 20 can support a maximum of eight antennas, and CRSs capable of supporting only four antennas have a limit to the measurement of a channel state and the estimation of a downlink channel. Therefore, an LTE-A system prescribes a UE-specific Reference Signal (or a Demodulation Reference Signal (DM-RS), which is a reference signal for estimating a downlink channel, and a Channel State Information Reference Signal (CSI-RS) which is a reference signal for measuring a channel state. Each of a DM-RS and a CSI-RS is a reference signal specified for a UE.

CSI-RSs may be allocated to one RE for each antenna port at intervals of 5, 10, 20, 40 or 80 subframes along the time axis, and in an area of 12 subcarriers corresponding to one Resource Block (RB) along the frequency axis. The next generation communication technologies can support a maximum of eight antennas in downlink, and can also allocate a maximum of eight CSI-RSs. CSI-RSs may be transmitted through one (p=15) antenna port, two (p=15 and 16) antenna ports, four (p=15 to 18) antenna ports, or eight (p=15 to 22) antenna ports.

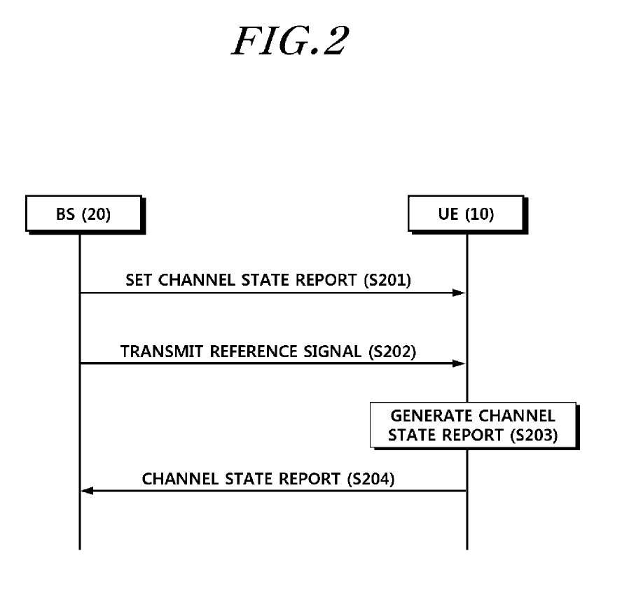

FIG. 2 is a signal flow diagram illustrating an example of a method for reporting a channel state in the communication system illustrated in FIG. 1.

Referring to FIG. 2, the BS 20 transmits a setting of a channel state report to the UE 10, in step S201. The setting may be transmitted through higher layer signaling (e.g., Radio Resource Control (RRC) signaling).

RRC signaling includes a parameter I_{CQI/PMI} indicating a period N_{pd} and an offset N_{OFFSET,CQI} for a CQI/PMI report, a parameter(K) for determining a period of a wideband CQI/PMI report, and a parameter I_{RI} indicating a relative period M_{RI} and a relative offset N_{OFFSET,RI} for an RI report.

The UE 10 determines a period and an offset for a CQI/PMI report by using the parameter I_{CQI/PMI} and Table 1, determines a period for a wideband CQI/PMI report by using the number J of subbands and the parameter K, and determines a period and an offset for an RI report by using the parameter I_{RI} and Table 2.

The BS 20 periodically transmits a reference signal to the UE 10 in step S202. A CRS is transmitted in each downlink subframe, and CSI-RSs may be transmitted at intervals of 5, 10, 20, 40 or 80 subframes.

The UE 10 generates a channel state report including one or more pieces of CSI among multiple pieces of CSI (e.g., CQI, PMI and RI) based on the received reference signal, in step S203.

In step S204, the UE 10 transmits the channel state report to the BS 20, in an uplink subframe determined based on the period and the offset for the CQI/PMI report and the period and the offset of the RI report, which have been determined by the parameters included in the RRC and Table 1 and Table 2.

When an aperiodic channel state report is set in an uplink subframe in which a periodic channel state report is transmitted, the aperiodic channel state report is transmitted and the periodic channel state report may be cancelled.

When transmission through a PUSCH is not reserved in an uplink subframe in which a periodic channel state report is transmitted, the periodic channel state report is transmitted through a PUCCH. When the transmission through the PUSCH is reserved in the uplink subframe in which the periodic channel state report is transmitted, the periodic channel state report is transmitted together with data through the PUSCH.

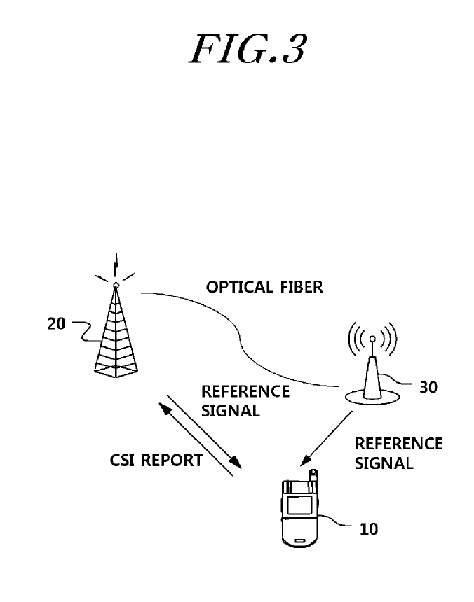

FIG. 3 illustrates an example of a communication system, to which exemplary embodiments of the present invention are applied.

The communication network system illustrated in FIG. 3 is a heterogeneous network system configured to enable the UE 10 to communicate with multiple transmission points 20 and 30. The multiple transmission points 20 and 30 include the wide-area transmission point 20 having a wide coverage; and the one or more coordinated transmission points 30 which all have a small coverage and are located inside or outside the coverage area of the wide-area is transmission point 20.

In order to extend the coverage of the BS and solve a shadow area problem, the communication system can use a repeater, such as a Radio Remote Head (RRH) connected by a wire (e.g., an optical fiber) to the BS, a relay node which is wirelessly connected to the BS, or the like. The UE may communicate with a transmission point, such as an RRH adjacent to the UE, a relay node adjacent to the UE, or the like, as well as the BS.

Meanwhile, a communication system in which BSs or transmission points have coverage areas all having an identical level or having similar levels and are configured independently of each other can be referred to as a so-called “homogeneous network.” A heterogeneous network can be defined as a concept distinguished from the concept of the homogeneous network.

A communication network including multiple cells or transmission points having coverage areas which partially or entirely overlap each other can be referred to as a “heterogeneous network.” In a heterogeneous network which has overlapping areas, the UEs may simultaneously receive or transmit signals and information to/from the two or more transmission points.

Here, the transmission point has a broad concept including a BS, an RRH, a relay node, and the like.

Meanwhile, the heterogeneous network can provide a better communication is quality than the homogeneous network, through a scheduling technique which flexibly designates a transmission point, which is to communicate with each of the UEs, and a bandwidth, which each UE is to use, and the like according to a distribution state of the UEs connected to the heterogeneous network, a channel state of each UE connected to the heterogeneous network, and the like.

For example, when a UE requiring high-speed information communication causes RRHs to be installed in many areas and provides communication to UEs located in the many areas through the RRHs, the UEs located in the many areas can receive services for high-speed transmission of information through the RRHs. Accordingly, this configuration brings about an increase in the overall communication efficiency of the communication network.

A latest communication system considers the use of a coordinated multi-point wireless communication system (i.e., a Coordinated Multi-Point Tx/Rx Communication System (CoMP)), in which a UE simultaneously receives information from multiple transmission points, or in which multiple transmission points transmit information to an identical UE through coordinated communication while the multiple transmission points are controlled by an identical scheduler.

When the CoMP system is introduced to the heterogeneous network, each UE can not only communicate with one transmission point (e.g., a BS or an RRH) but also can communicate with the multiple transmission points. Also, scheduling is performed which is changes transmission points, which are to perform communication so as to be appropriate for a channel situation and a network situation, and the number of the transmission points, and thereby higher scheduling gain can be obtained.

In an example illustrated in FIG. 3, the wide-area transmission point 20 may be a BS of a macrocell, and the coordinated transmission point 30 may be an RRH connected by wire to the BS. However, embodiments of the present invention are not limited thereto. A transmission point has a broad concept including all transmission points which all have an identical identifier and can simultaneously transmit/receive information to/from an identical UE, as described below. Hereinafter, a BS will be described as an example of the wide-area transmission point 20, and an RRH will be described as an example of the coordinated transmission point 30.

Referring to FIG. 3, the BS 20 and the one or more RRHs 30 are configured to have a cell Identification (ID) of an identical identifier in order to allow switching between transmission points for downlink without a handover process, and the BS 20 and the one or more RRHs 30 can communicate in downlink with each UE 10 while the BS 20 and the one or more RRHs 30 all have the identical cell ID. Meanwhile, each UE 10 may individually communicate in uplink with either the BS 20 or the one or more RRHs 30. Otherwise, each UE 10 may simultaneously communicate in uplink with the BS 20 and the one or more RRHs 30.

Scheduling for uplink communication and downlink communication between the UE 10 and the transmission points 20 and 30 can be set by the BS 20. The BS 20 can perform scheduling which changes transmission points, which are to perform communication so as to be appropriate for a channel situation and a network situation, and the number of the transmission points.

A PDSCH which is a main physical channel for unicast transmission, may be transmitted by the BS 20 and/or the RRH 30. The PDSCH may be transmitted by one transmission point which has a good channel state among the multiple transmission points 20 and 30, or may be transmitted by the multiple coordinated transmission points 20 and 30. When data is transmitted by the multiple transmission points 20 and 30, data that the transmission point 20 transmits may be identical to or different from data that the transmission point 30 transmits. Whether data that the transmission point 20 transmits is identical to or different from data that the transmission point 30 transmits, is determined by a provision method that the BS 20 has set.

Downlink control information such as scheduling required to receive a PDSCH and the like, and a PDCCH for transmitting a scheduling grant for transmitting a PUSCH can be transmitted by the BS 20 having a wide coverage.

A CRS which is a reference signal that all the UEs 10 in a macrocell commonly use is transmitted by one transmission point in the macrocell, and may be transmitted by the BS 20 having a wide coverage.

When the particular UE 10 receives data from the BS 20 and/or the RRH 30, a CSI-RS which is a reference signal for detecting CSI may be transmitted by the BS 20 and/or the RRH 30 which transmits data to the UE 10.

The UE 10 performs uplink transmission to the transmission points 20 and 30. Because the multiple transmission points 20 and 30 all have an identical cell ID, the UE 10 does not perform uplink transmission to one transmission point after the UE 10 specifies the one transmission point among the multiple transmission points 20 and 30. Specifically, a PUSCH which is a main physical channel for unicast transmission, a Hybrid Automatic Repeat Request (HARQ) Acknowledgement (ACK)/Negative Acknowledgement (NACK) notifying of whether a downlink transmission block has been successfully received, a channel state report, and an SR which is a scheduling request signal requiring resource allocation when data is intended to be transmitted in uplink are not transmitted to one transmission point after the one transmission point is specified among the multiple transmission points 20 and 30.

A uplink signal that the UE 10 has transmitted without specifying one transmission point among the multiple transmission points 20 and 30, may be received directly by the BS 20. Otherwise, the uplink signal may be received by the RRH 30, and then the RRH 30 delivers the uplink signal to the BS 20.

FIG. 3 illustrates a case in which the multiple transmission points 20 and 30 transmit downlink data to the UE 10 through a PDSCH, as a case to which exemplary embodiments of the present invention are applied. Although the BS 20 and the one RRH 30 is transmit downlink data to the UE 10 as illustrated in FIG. 3, the case illustrated in FIG. 3 is only an example. Accordingly, embodiments of the present invention are not limited thereto. The transmission point which transmits downlink data to the UE may include multiple RRHs. The two or more transmission points which transmit downlink data to the UE may be included. Also, the transmission point which transmits downlink data to the UE is wirelessly connected to the BS, and may include a relay node having a cell ID identical to that of the BS.

In order to perform downlink channel-dependent scheduling, the BS 20 requires CSI on all channels through which downlink data is transmitted to the UE 10. Specifically, in an example illustrated in FIG. 3, state information on a channel (i.e., a PDSCH) through which the BS 20 transmits downlink data to the UE 10 and state information on a channel (i.e., a PDSCH) through which the RRH 30 transmits downlink data to the UE 10 are required.

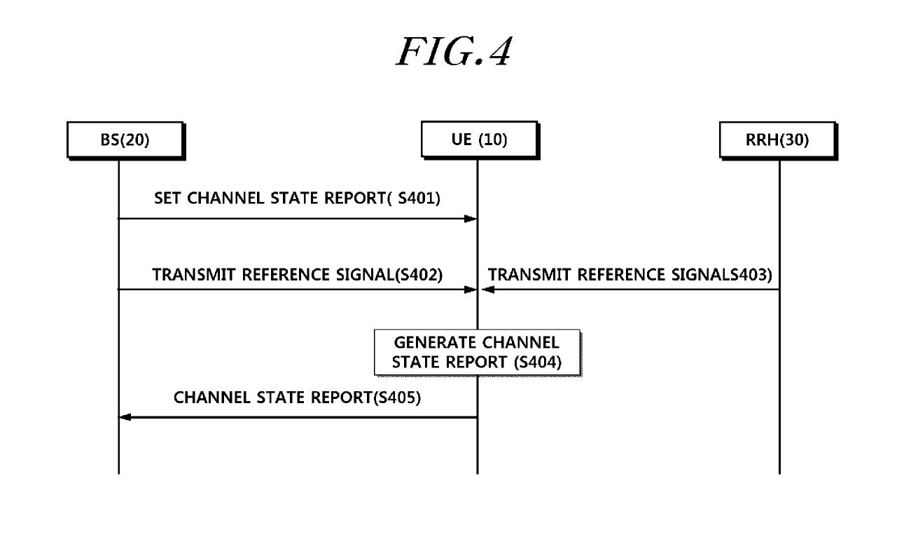

FIG. 4 is a signal flow diagram illustrating an example of a method for reporting a channel state in the communication system illustrated in FIG. 3.

Referring to FIG. 4, the BS 20 transmits a setting of a periodic channel state report to the UE 10 in step S401. The setting may be transmitted through higher layer signaling (e.g., RRC signaling). The RRC signaling includes a parameter indicating a period and an offset for a CQI/PMI report, and a parameter indicating a period and an offset for an RI report. Otherwise, the setting may be transmitted through a PDCCH.

In step S402, the BS 20 transmits a CRS and a CSI-RS as reference signals for is detecting CSI. The RRH 30 transmits a CSI-RS as a reference signal for detecting CSI, in step S403.

After receiving the reference signal, the UE 10 generates a channel state report in step S404. The UE 10 determines a subframe, in which a periodic channel state report is to be transmitted, based on the parameters received in step S401 and transmits a periodic channel state report corresponding to the determined subframe, in step S405. The periodic channel state report that the UE 10 has transmitted may be delivered directly to the BS 20, or may be delivered to the BS 20 through the RRH 30.

The UE 10 receives data from the multiple transmission points (the BS 20 and the RRH 30 in an example illustrated in FIG. 3), and thus needs to transmit a periodic channel state report on a channel which is set for each of the transmission points 20 and 30.

To this end, a period and an offset to be used to transmit the periodic channel state report on each of the transmission points 20 and 30 need to be designated independently of each other.

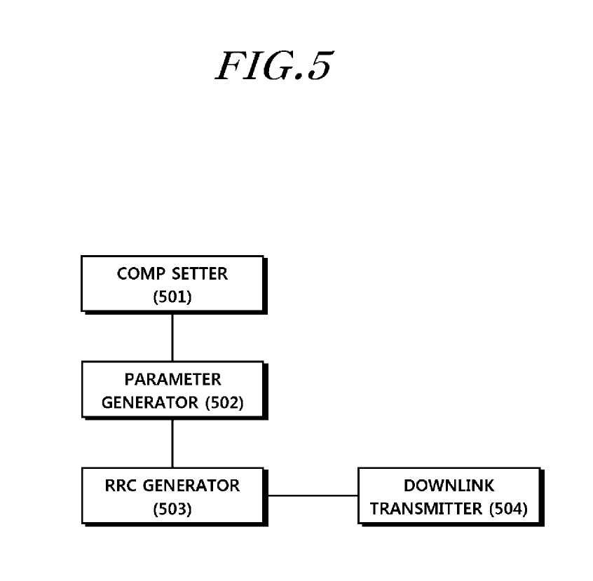

FIG. 5 is a block diagram illustrating a configuration of an apparatus 500 for periodic channel state report setting transmission according to an embodiment of the present invention. The apparatus 500 for periodic channel state report setting transmission may be an apparatus for periodic channel state report setting transmission in the BS 20.

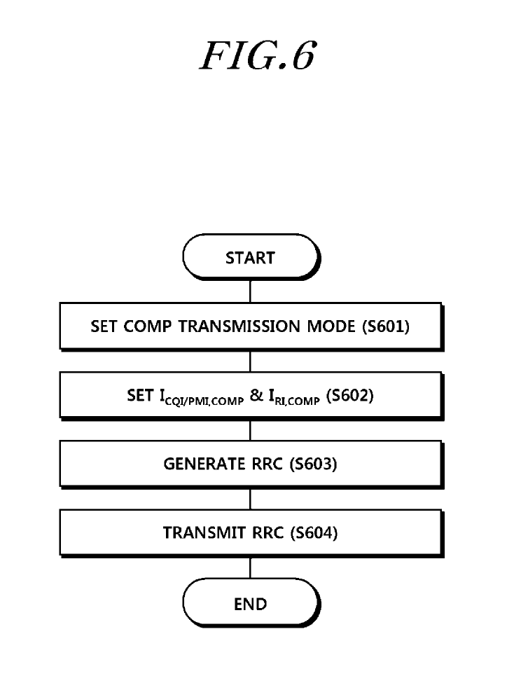

FIG. 6 is a flowchart illustrating a method for providing a setting by the apparatus 500 for the periodic channel state report setting transmission as illustrated in FIG. 5.

Referring to FIG. 5, the apparatus 500 for periodic channel state report setting transmission includes a CoMP setter 501 which sets the multiple transmission points 20 and 30 which are to transmit data to the UE 10 through a PDSCH, a parameter generator 502 which sets parameters for a channel state report related to the transmission points 20 and 30 that the CoMP setter 501 has set, an RRC generator 503 which generates RRC signaling including the parameters generated by the parameter generator 502, and a downlink transmitter 504 that transmits the RRC signaling generated by an RRC generator 503.

In the flowchart illustrated in FIG. 6, after the CoMP setter 501 selects the transmission points 20 and 30 which are to transmit a PDSCH to the UE 10 and a CoMP transmission mode is set in step S601, the parameter generator 502 generates a parameter indicating a period and an offset for a CQI/PMI report, and a parameter indicating a period and an offset for an RI report, with respect to each of the transmission points which transmit a PDSCH to the UE 10, in step S602.

For example, when the communication system illustrated in FIG. 3 includes an (M+1) number of transmission points 20 and 30 including one BS 20 and an M number of RRHs 30, the transmission points 20 and 30 are distinguished from each other by using an index CoMP(m) (0≦m≦M), and an index CoMP(0) may be designated for the BS 20.

When the multiple transmission points 20 and 30 are set to transmit a PDSCH to is the UE 10, the parameter generator 502 generates a parameter indicating a period and an offset for a CQI/PMI report, and a parameter indicating a period and an offset for an RI report, with respect to each of the transmission points which transmit a PDSCH to the UE 10.

For example, when the BS 20 having an identifier CoMP(0) and the RRH 30 having an identifier CoMP(n) (1≦n≦M) are set to transmit a PDSCH to the UE 10, the parameter generator 502 generates a parameter I_{CQI/PMI,CoMP(0)} indicating a period and an offset for a CQI/PMI report and a parameter I_{RI,CoMP(0)} indicating a period and an offset for an RI report, on a channel on the side of the BS 20. Also, the parameter generator 502 generates a parameter I_{CQI/PMI,CoMP(n)} (1≦n≦M) indicating a period and an offset for a CQI/PMI report and a parameter I_{RI,CoMP(n)} (1≦n≦M) indicating a period and an offset for an RI report, on a channel on the side of the RRH 30. The parameter I_{CQI/PMI,CoMP(0)} indicating the period and the offset for the CQI/PMI report and the parameter I_{RI,CoMP(0)} indicating the period and the offset for the RI report, both of which are related to a channel on the side of the BS 20 may be respectively represented by “I_{CQI/PMI}” and “I_{RI}” in order to have compatibility with parameters used in the system illustrated in FIG. 1.

When a parameter K is different for each transmission point, the parameter generator 502 may generate a parameter K_{CoMP(m)} (0≦m≦M) related to each transmission point. Each parameter related to a channel on the side of the BS 20 may be represented by using “K” in order to have compatibility with each existing parameter used in the system illustrated in FIG. 1.

The RRC generator 503 generates RRC signaling including the parameter indicating the period and the offset for the CQI/PMI report and the parameter indicating the period and the offset for the RI report, with respect to each of the transmission points 20 and 30, in step S603. The downlink transmitter 504 transmits the generated RRC signaling in step S604.

When the BS 20 switches the system in order to cause the multiple transmission points 20 and 30 to transmit a PDSCH to the UE 10, the BS 20 may generate and transmit the parameters.

Although a case has been described in which the parameters are transmitted through RRC signaling, the parameters may also be transmitted through a PDCCH.

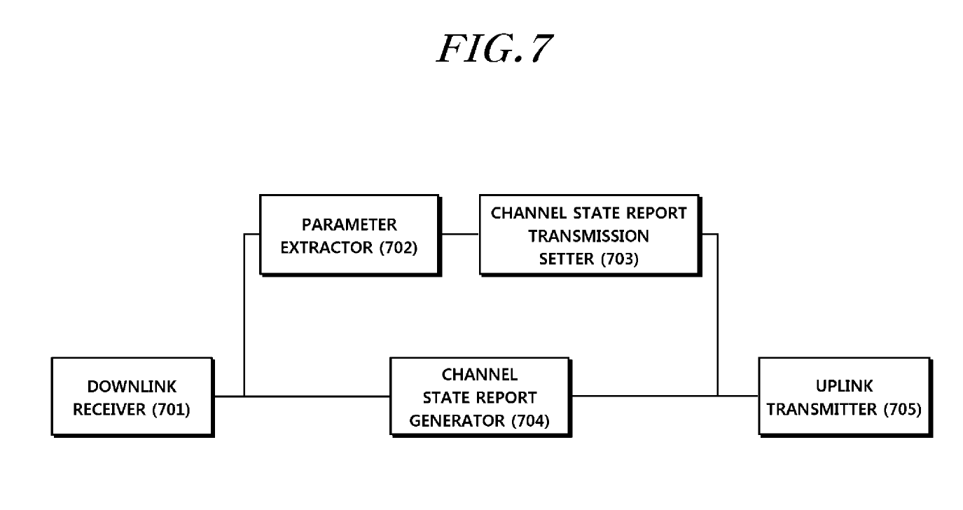

FIG. 7 is a block diagram illustrating a configuration of an apparatus 700 for a periodic channel state report according to an embodiment of the present invention. The apparatus 700 for a periodic channel state report may be an apparatus for a periodic channel state report in the UE 10.

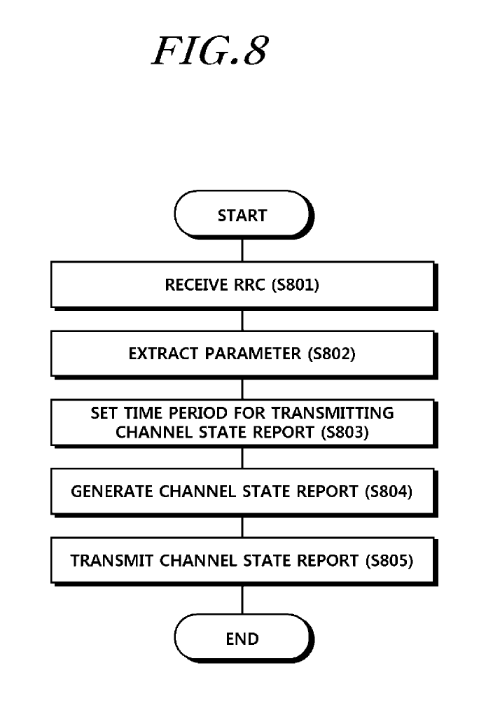

FIG. 8 is a flowchart illustrating a method for reporting a channel state by the apparatus 700 for the periodic channel state report as illustrated in FIG. 7, according to an embodiment of the present invention.

Referring to FIG. 7, the apparatus 700 for a periodic channel state report includes a downlink receiver 701 which receives a downlink signal; a parameter extractor 702 which extracts a setting parameter related to a periodic channel state report received through the downlink receiver 701; a channel state report transmission setter 703 which determines a subframe, in which a channel state report is to be transmitted, by using the parameter that the parameter extractor 702 has extracted; a channel state report generator 704 which generates a channel state report based on a reference signal (e.g., a CRS, a CSI-RS, or the like) received through the downlink receiver 701; and an uplink transmitter 705 which transmits the relevant channel state report, that the channel state report generator 704 has generated, in the subframe that the channel state report transmission setter 703 has set.

Referring to FIG. 8, the downlink receiver 701 receives RRC signaling in step S801. The parameter extractor 702 extracts a parameter for determining a period and an offset for a periodic channel state report from the RRC signaling, in step S802. Meanwhile, when a parameter is transmitted through a PDCCH, the parameter extractor 702 may extract the parameter from a downlink control signal transmitted through the PDCCH.

When the UE 10 receives a PDSCH from the multiple transmission points 20 and 30, parameters that the parameter extractor 702 extracts include a parameter I_{CQI/PMI,CoMP(m)} (0≦m≦M) indicating a period and an offset for a CQI/PMI report and a parameter I_{RI,CoMP(m)} (0≦m≦M) indicating a period and an offset for an RI report, on each of the transmission points 20 and 30. Also, the parameters that the parameter extractor 702 extracts may include a parameter K_{CoMP(m)} (0≦m≦M).

The channel state report transmission setter 703 determines a subframe (time), in is which a periodic channel state report is to be transmitted, based on the parameters extracted by the parameter extractor, in step S803. The channel state report transmission setter 703 determines a subframe, in which the CQI/PMI report on each of the transmission points 20 and 30 is to be transmitted, by using the parameter I_{CQI/PMI,CoMP(m)} (0≦m≦M) indicating the period and the offset for the CQI/PMI report on each of the transmission points 20 and 30 and Table 1. The channel state report transmission setter 703 determines a period for a wideband CQI/PMI report on each of the transmission points 20 and 30 by using the number J of subbands and a parameter K or a parameter K_{CoMP(m)}. Then, the channel state report transmission setter 703 determines a subframe, in which an RI report on each of the transmission points 20 and 30 is to be transmitted, by using the parameter I_{RI,CoMP(m)} (0≦m≦M) and Table 2.

The uplink transmitter 705 transmits a relevant channel state report from among channel state reports, that the channel state report generator 704 has generated, in the subframe that the channel state report transmission setter 703 has set, in step S804. The channel state report may be transmitted through a PUCCH. Otherwise, when the relevant uplink subframe includes an uplink PUSCH, the channel state report may be transmitted through a PUSCH.

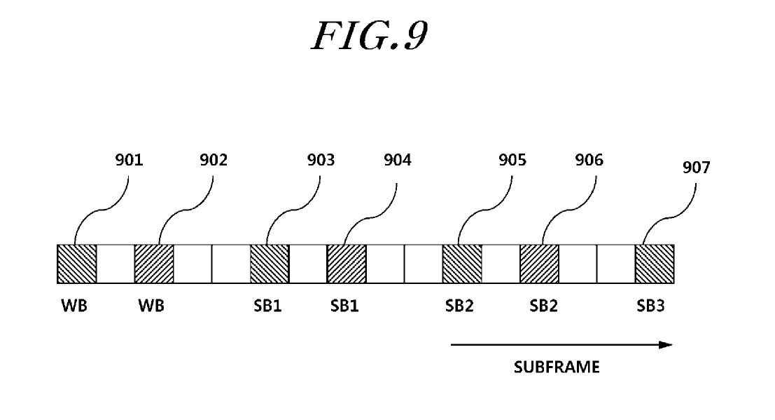

FIG. 9 illustrates an example of a periodic channel state report transmitted by the apparatus 700 for the periodic channel state report.

FIG. 9 illustrates an example in which the BS 20 and the one the RRH 30 transmit a PDSCH to the UE.

When a parameter I_{CQI/PMI,CoMP(0)} or I_{CQI/PMI} indicating a period and an offset for a CQI/PMI report on the side of the BS 20 is set to have a value of 2, a period N_{pd} for the CQI/PMI report on the side of the BS 20 is determined as 5 subframes and an offset N_{OFFSET,CQI} for the CQI/PMI report on the side of the BS 20 is determined as 0 (=I_{CQI/PMI,CoMP(0)}−2), from Table 1.

When a parameter I_{CQI/PMI, CoMP(m)} (1≦n≦M) indicating a period and an offset for a CQI/PMI report on the side of the RRH 30 is set to have a value of 4, a period N_{pd} for the CQI/PMI report on the side of the RRH 30 is determined as 5 subframes and an offset N_{OFFSET,CQI} for the CQI/PMI report on the side of the RRH 30 is determined as 2 (=I_{CQI/PMI,CoMP(m)}−2), from Table 1.

Referring to FIG. 9, the UE 10 transmits a wideband CQI/PMI report WB on the side of the BS 20 through a PUCCH or PUSCH in a subframe 901 having an offset of 0, and transmits subband CQI/PMI reports SB1, SB2 and SB3 on the side of the BS 20 through a PUCCH or PUSCH in subframes 903, 905 and 907 which are spaced from each other at intervals of 5 subframes, respectively.

The UE 10 transmits a wideband CQI/PMI report WB on the side of the RRH 30 through a PUCCH or PUSCH in a subframe 902 having an offset of 2, and transmits subband CQI/PMI reports SB1 and SB2 on the side of the RRH 30 through a PUCCH or PUSCH in subframes 904 and 906 which are spaced from each other at intervals of 5 subframes, respectively.

Meanwhile, the LTE/LTE-A system defines the use of multiple Component Carriers (CCs) which are multiple unit carriers, as a method for extending a bandwidth in order to satisfy a system requirement, namely, a high data transmission rate. In the LTE/LTE-A system, one CC may have a bandwidth of up to 20 MHz, and resources may be allocated to one CC within 20 MHz according to a relevant service. However, this configuration is only an embodiment of the present invention according to a process for implementing the system, and thus CCs may be set to have a bandwidth greater than or equal to 20 MHz, depending on the implementation of the system. Also, the use of a Carrier Aggregation (CA) technology for aggregating multiple CCs and using the multiple aggregated CCs as one system band may be defined.

For example, when use is made of five CCs each having a maximum bandwidth of 20 MHz, the quality of service is supported by extending a bandwidth up to a maximum of 100 MHz. Allocable frequency bands that respective CCs can determine may be contiguous or non-contiguous according to the scheduling of an actual CA.

In a CA environment, in order to efficiently manage multiple CCs, the multiple CCs may be divided into one Primary Component Carrier (PCC) and one or more Secondary Component Carriers (SCCs). Otherwise, a PCC may be referred to as a Primary cell (P cell), and a SCC may be referred to as a Secondary cell (S cell).

The PCC may serve as a core carrier for managing all of the aggregated CCs, and is the other SCCs may serve to provide additional frequency resources for providing a higher transmission rate. For example, in downlink, a PDCCH including DCI for controlling downlink may be transmitted through only a PCC.

Otherwise, in order to efficiently manage multiple CCs, serving cell indexes ServCellIndex may be designated for the multiple CCs. For example, when five CCs CC0, CC1, CC2, CC3 and CC4 are aggregated, 0 to 4 may be designated for serving cell indexes ServCellIndexes of the five CCs. In the present example, CC0 having a serving cell index of 0 may be a PCC, and CC1 to CC4 which respectively have serving cell indexes from 1 to 4 may be SCCs.

In this case, a parameter indicating a period and an offset for a CQI/PMI report and a parameter indicating a period and an offset for an RI report are independently set for each of the transmission points and for each of the CCs.

For example, when the communication system illustrated in FIG. 3 includes an (M+1) number of transmission points 20 and 30 including one BS 20 and an M number of RRHs 30, the transmission points 20 and 30 are distinguished from each other by using an index CoMP(m) (0≦m≦M), and an index CoMP(0) may be designated for the BS 20. When the transmission points 20 and 30 use a CA technology in which an L number of CCs are aggregated and used as one system band, the CCs are distinguished from each other by using an index CC(l) (0≦l≦L−1), and an index CC(0) may be designated for a PCC.

In this case, with respect to the CC having an index CC(l), the transmission point having an index CoMP(m) may use I_{CQI/PMI,CoMP(m),CC(l)} as a parameter indicating a period and an offset for a CQI/PMI report, and may use I_{RI,CoMP(n),CC(l)} as a parameter indicating a period and an offset for an RI report. Both a parameter indicating a period and an offset for a CQI/PMI report for a PCC of the BS 20, and a parameter indicating a period and an offset for an RI report for the PCC of the BS 20 may be respectively represented by “I_{CQI/PMI}” and “I_{RI}” in order to have compatibility with the parameters used in the system illustrated in FIG. 1.

The parameter I_{CQI/PMI,CoMP(m),CC(l)} indicating the period and the offset for the CQI/PMI report and the parameter I_{RI,CoMP(m),CC(l)} indicating the period and the offset for the RI report can be set by the method illustrated in FIG. 6 in the apparatus 500 for periodic channel state report setting transmission as illustrated in FIG. 5. Also, the apparatus 700 for a periodic channel state report as illustrated in FIG. 7 can transmit a periodic channel state report in a subframe determined by the method illustrated in FIG. 8, which uses the parameter I_{CQI/PMI,CoMP(m),CC(l)} indicating the period and the offset for the CQI/PMI report and the parameter I_{RI,CoMP(m),CC(l)} indicating the period and the offset for the RI report.

Meanwhile, in the LTE-A system, when a PUCCH is not transmitted simultaneously with a PUSCH, only one periodic channel state report may be transmitted in one uplink subframe. When subframes in which periodic channel state reports on the multiple transmission points (or periodic channel state reports on multiple CCs in the multiple is transmission points) are transmitted collide with each other, only a periodic channel state report on one transmission point (or one CC in the one transmission point) is transmitted in the uplink subframe, and another periodic channel state report may be cancelled.

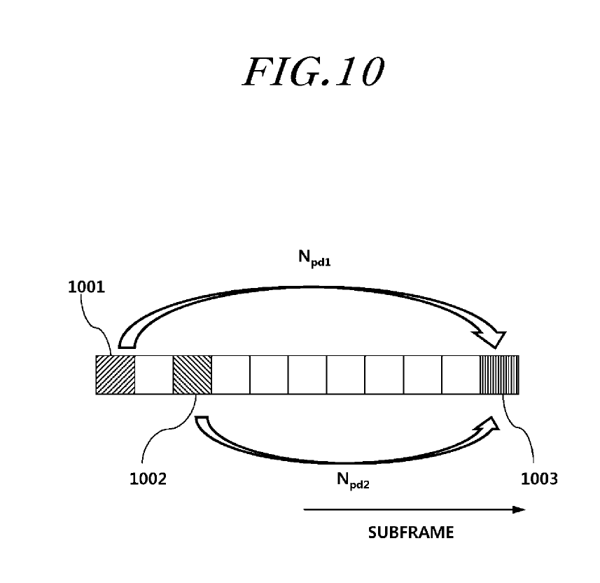

FIG. 10 illustrates an example of a case in which two periodic channel state reports overlap in one uplink subframe.

Referring to FIG. 10, a first periodic channel state report is periodically transmitted in a period N_{pd1} of 10 subframes and with an offset N_{offset1} of 0 subframe, and a second periodic channel state report is periodically transmitted in a period N_{pd2} of 8 subframes and with an offset N_{offset2} of 2 subframes.

The first periodic channel state report is to be transmitted in subframes 1001 and 1003, and the second periodic channel state report is to be transmitted in a subframe 1002 and the subframe 1003. The first periodic channel state report and the second periodic channel state report are reserved to be transmitted in the subframe 1003. However, in this case, only one of the first periodic channel state report and the second periodic channel state report may be transmitted.

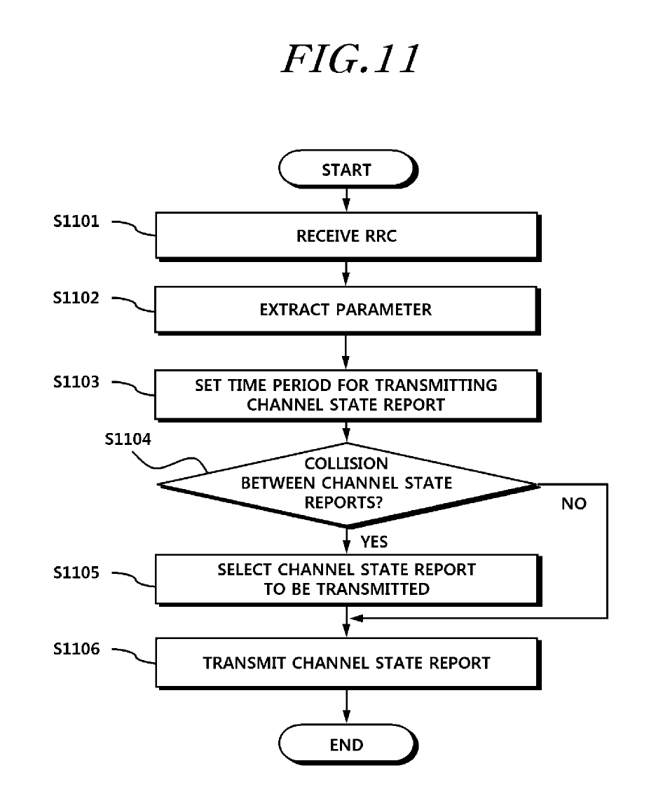

FIG. 11 is a flowchart illustrating a method for periodically reporting a channel state by the apparatus 700 for the channel state report as illustrated in FIG. 7, according to another embodiment of the present invention.

Referring to FIG. 7 and FIG. 11, the downlink receiver 701 receives RRC is signaling in step S1101. The parameter extractor 702 extracts a parameter for determining a period and an offset for a periodic channel state report from the RRC signaling, in step S1102. Meanwhile, when a parameter is transmitted through a PDCCH, the parameter extractor 702 may extract the parameter from a downlink control signal transmitted through the PDCCH.

When the UE 10 receives a PDSCH from the multiple transmission points 20 and 30, parameters that the parameter extractor 702 extracts include a parameter I_{CQI/PMI,CoMP(m)} indicating a period and an offset for a CQI/PMI report and a parameter I_{RI,CoMP(m)} indicating a period and an offset for an RI report, on each of the transmission points 20 and 30. Also, the parameters that the parameter extractor 702 extracts may include a parameter K_{CoMP(m)}.

Meanwhile, when the UE 10 receives a PDSCH from the multiple transmission points 20 and 30 through one or more CCs, parameters that the parameter extractor 702 extracts include a parameter I_{CQI/PMI,CoMP(m),CC(l)} indicating a period and an offset for a CQI/PMI report and a parameter I_{RI,CoMP(m),CC(l)} indicating a period and an offset for an RI report, on each CC of each of the transmission points 20 and 30. Also, the parameters that the parameter extractor 702 extracts may include a parameter K_{CoMP(m),cc(l)} (0≦m≦M).

The channel state report transmission setter 703 determines a subframe (time), in which a periodic channel state report is to be transmitted, based on the parameters extracted by the parameter extractor, in step S1103.

The channel state report transmission setter 703 determines a subframe, in which is a CQI/PMI report on each of the transmission points 20 and 30 or on each CC of each of the transmission points 20 and 30 is to be transmitted, by using the parameter I_{CQI/PMI,CoMP(m)} indicating the period and the offset for the CQI/PMI report on each of the transmission points 20 and 30, or the parameter I_{CQI/PMI,CoMP(m),CC(l)} indicating the period and the offset for the CQI/PMI report on each CC of each of the transmission points 20 and 30, and Table 1.

The channel state report transmission setter 703 determines a period for a wideband CQI/PMI report on each of the transmission points 20 and 30 or on each CC of each of the transmission points 20 and 30, by using the number J of subbands, a parameter K, and the parameter K_{CoMP(m)} (or the parameter K_{CoMP(m),CC(l)}).

Then, the channel state report transmission setter 703 determines a subframe, in which an RI report on each of the transmission points 20 and 30 or on each CC of each of the transmission points 20 and 30 is to be transmitted, by using the parameter I_{RI,CoMP(m)} or the parameter I_{RI,CoMP(m),CC(l)} and Table 2.

Next, the channel state report transmission setter 703 determines whether different channel state reports are transmitted simultaneously (in one uplink subframe) and thus a collision between the different channel state reports occurs, in step S1104. When the collision between the different channel state reports does not occur (No in step S1104), a channel state report is transmitted during the transmission time period, which has been set in step S1103, in step S1106.

When the collision between the different channel state reports occurs (Yes in step S1104), the channel state report transmission setter 703 selects which channel state report is to be transmitted among the channel state reports which have collided with each other, in step S1105.

The periodic channel state report selected in step S1105 is transmitted through the uplink transmitter 705, in step S1106. The transmission of a periodic channel state report which has not been selected is cancelled. The transmitted periodic channel state report may be delivered directly to the BS. Otherwise, the transmitted periodic channel state report may be received by the RRH, and then the RRH delivers the periodic channel state report to the BS.

The selection in step S1105 of a channel state report which is to be transmitted among the channel state reports which have collided with each other will be described in detail below.

An example of priority of channel state reports is shown in Table 3 below.

TABLE 3

| | |
|---|---|
| Case 1-1 | 1. priority which is based on CSI-RS |
| | resources |
| Case 1-2 | 1. priority which is based on the type of |
| | channel state report |
| | 2. priority which is based on CSI-RS |
| | resources |

Case 1-1

The channel state report transmission setter 703 can select a channel state report to be transmitted, based on which CSI-RS resource each channel state report is about (in other words, based on which transmission point each channel state report is about).

The priority of channel state reports may follow predetermined rules.

Otherwise, the BS 20 illustrated in FIG. 3 or the apparatus 500 for periodic is channel state report setting transmission as illustrated in FIG. 5 may set the priority of periodic channel state reports between the multiple transmission points 20 and 30, and may transmit the set priority to the apparatus 700 for the periodic channel state report through RRC signaling.

For example, when the BS sets the multiple transmission points so as to transmit a PDSCH to the UE, the apparatus for periodic channel state report setting transmission further sets an indicator (or an index of a transmission point) indicating which transmission point is related to a channel state report for which priority is to be set, as well as a parameter indicating a period and an offset for a periodic channel state report on each transmission point, and transmits the set indicator or index to the UE.

The priority is determined in view of a distance between the UE and each transmission point, the amount of downlink data of each transmission point, the distribution of other UEs in a macrocell, and the like. The priority may be set in the order of the BS and the RRH, or may be set in reverse order to the above.

The priority may be set by a 1-bit or n-bit indicator. For example, when the BS and the one RRH transmit a PDSCH to the UE, if an indicator has 1 bit and has a value of 0, priority may be given to the BS. If the indicator has 1 bit and has a value of 1, priority may be given to the RRH.

Otherwise, a unique transmission point index TPindex may be assigned to each transmission point which transmits a PDSCH to the UE, and priority may be given to a transmission point having a low transmission point index TPindex. For example, when the BS and the two RRHs transmit a PDSCH to the UE, the BS, the first RRH and the second RRH are respectively set to have transmission point indexes TPindexes of 1, 0 and 2, and thereby priority may be set in the order of the first RRH, the BS and the second RRH.

The channel state report transmission setter 703 selects a transmission point, a channel state report on which is to be transmitted, based on the set indicator or index. The transmission of a channel state report which has not been selected is cancelled.

Case 1-2

The channel state report transmission setter 703 may select a channel state report to be transmitted, based on the type of each channel state report.

An example of priority according to the type of channel state report is shown in Table 4 below.

TABLE 4

| | |
|---|---|
| 1^{st} priority | type 3, 5, 6, 2a |
| 2^{nd} priority | type 2, 2b, 2c, 4 |
| 3^{rd} priority | type 1, 1a |

In Table 4, the type 3, 5, 6 and 2a reports may have the highest priority. The type 3, 5, 6 and 2a reports may be types 3, 5 and 6 which are related to an RI, or may be type 2a related to a wideband PMI. Because an RI is reported in a longer period than a CQI/PMI and the value of the RI affects the determination of a PMI, the types 3, 5 and 6 which are related to the RI may have the highest priority. Because a wideband PMI is transmitted only when a PTI is set to have a value of 0 and the type 2a report affects the type 2b report, the type 2a report may have the highest priority.

The type 2, 2b, 2c and 4 reports which are of types related to a wideband CQI may have the next priority.

The type 1 and 1a reports which are of types related to a subband CQI may have the lowest priority.

As another example, the type 3, 5 and 6 reports related to an RI may be set to have the highest priority, the type 2, 2a, 2b, 2c and 4 reports related to wideband feedback may be set to have the next priority, and the type 1 and 1a reports related to subband feedback may be set to have the lowest priority.

The above priority according to the type of channel state report is only an example, and priority different from the above priority may depend on the classification of channel state reports in another scheme.

The priority according to the type of channel state report may be prescribed in advance, or may be dynamically determined through RRC signaling.

When channel state reports of types all having identical priority collide with each other, for example, when a channel state report of type 3 of the BS collides with a channel state is report of type 5 of the RRH, the channel state report transmission setter 703 can select a channel state report to be transmitted, based on which CSI-RS resource each channel state report is about.

As in the above-described Case 1-1, the priority may follow predetermined rules.

Otherwise, an indicator (or an index of a transmission point) indicating which one of the multiple transmission points is related to a channel state report for which priority is to be set, may be determined through RRC signaling. Based on the set indicator or the set transmission point index, the channel state report transmission setter 703 determines which transmission point is related to a channel state report which has priority among channel state reports of types all having identical priority.

The above-described Cases 1-1 and 1-2 correspond to a case in which the multiple transmission points transmit a PDSCH without using the CA technology. Table 5 below shows an example of priority of channel state reports in a case where the multiple transmission points transmit a PDSCH and use the CA technology.

TABLE 5

| | |
|---|---|
| case 2-1 | 1. priority which is based on a serving cell |
| | index |
| | 2. priority which is based on CSI-RS |
| | resources |
| case 2-2 | 1. priority which is based on CSI-RS |
| | resources |
| | 2. priority which is based on a serving cell |
| | index |
| case 2-3 | 1. priority which is based on the type of |
| | channel state report |
| | 2. priority which is based on a serving cell |
| | index |
| | 3. priority which is based on CSI-RS |
| | resources |
| case 2-4 | 1. priority which is based on the type of |
| | channel state report |
| | 2. priority which is based on CSI-RS |
| | resources |
| | 3. priority which is based on a serving cell |
| | index |
| case 2-5 | 1. priority which is based on CSI-RS |
| | resources |
| | 2. priority which is based on the type of |
| | channel state report |
| | 3. priority which is based on a serving cell |
| | index |

Case 2-1

The channel state report transmission setter 703 selects a channel state report based on which CC each channel state report is related to.

The transmission of a periodic channel state report for a PCC (ServCellIndex=0) of the BS and the transmission of a periodic channel state report for a PCC (ServCellIndex=0) of the RRH have the highest priority.

Also, the transmission of a periodic channel state report for a SCC (ServCellIndex>0) of the BS and the transmission of a periodic channel state report for a SCC (ServCellIndex>0) of the RRH have the next priority.

When transmissions of periodic channel state reports for multiple SCCs collide with each other, a periodic channel state report for a SCC having a low serving cell index ServCellIndex has priority.

In other words, when transmissions of periodic channel state reports for multiple CCs collide with each other, a periodic channel state report for a CC having a low serving cell is index ServCellIndex has priority.

The serving cell index ServCellIndex may be determined through RRC signaling.

When periodic channel state reports for CCs all having an identical serving cell index ServCellIndex collide with each other, for example, when a periodic channel state report for a PCC of the BS collides with a periodic channel state report for a PCC of the RRH, the channel state report transmission setter 703 may select a channel state report to be transmitted, based on which CSI-RS resource each channel state report is about.

As in the above-described Case 1-1, the priority between the transmission points may follow predetermined rules.

Otherwise, an indicator (or an index of a transmission point) indicating which one of the multiple transmission points is related to a channel state report for which priority is to be set, may be determined through RRC signaling. Based on the set indicator or the set transmission point index, the channel state report transmission setter 703 determines which transmission point is related to a channel state report which has priority among channel state reports of types all having identical priority.

Case 2-2

The channel state report transmission setter 703 may select a channel state report to be transmitted, based on which CSI-RS resource each channel state report is about.

As in the above-described Case 1-1, the priority between the transmission points is may follow predetermined rules.

Otherwise, an indicator (or an index of a transmission point) indicating which one of the multiple transmission points is related to a channel state report for which priority is to be set, may be determined through RRC signaling. Based on the set indicator or the set transmission point index, the channel state report transmission setter 703 determines which transmission point is related to a channel state report which has priority among channel state reports of types all having identical priority.

When periodic channel state reports related to different CCs of an identical transmission point collide with each other, for example, when a periodic channel state report for a PCC of the RRH collides with a periodic channel state report for a SCC of the RRH, the channel state report transmission setter 703 may select a channel state report based on which CC a periodic channel state report is related to. In other words, the channel state report transmission setter 703 selects the transmission of a periodic channel state report related to a CC having a low serving cell index ServCellIndex.

The serving cell index ServCellIndex may be determined through RRC signaling.

Case 2-3

The channel state report transmission setter 703 may select a channel state report to be transmitted, based on the type of each channel state report.

An example of priority according to the type of channel state report is shown in is Table 4 above.

When channel state reports of types all having identical priority collide with each other, for example, when one periodic channel state report is of type 3 and another periodic channel state report is of type 5, the channel state report transmission setter 703 may select a channel state report to be transmitted, based on which CC each periodic channel state report is related to, namely, based on a serving cell index ServCellIndex.

The serving cell index ServCellIndex may be determined through RRC signaling.

When priorities of types of channel state reports are all identical and serving cell indexes are all identical, for example, when one periodic channel state report is the type 3 report for a PCC of the BS and another periodic channel state report is the type 6 report for a PCC of the RRH, the channel state report transmission setter 703 may select a channel state report to be transmitted, based on which CSI-RS resource each periodic channel state report is about.

As in the above-described Case 1-1, priority between the transmission points may follow predetermined rules. Otherwise, the priority between the transmission points may be determined by an indicator (or an index of a transmission point) indicating which one of the multiple transmission points is related to a channel state report for which priority is to be set. Here, the indicator or the index of the transmission point is included in RRC signaling.

Case 2-4

The channel state report transmission setter 703 may select a channel state report is to be transmitted, based on the type of each channel state report.

An example of priority according to the type of channel state report is shown in Table 4 above.

When channel state reports of types all having identical priority collide with each other, for example, when one periodic channel state report is of type 3 and another periodic channel state report is of type 5, the channel state report transmission setter 703 may select a channel state report to be transmitted, based on which CSI-RS resource each periodic channel state report is about.

As in the above-described Case 1-1, priority between the transmission points may follow predetermined rules. Otherwise, the priority between the transmission points may be determined by an indicator (or an index of a transmission point) indicating which one of the multiple transmission points is related to a channel state report for which priority is to be set. Here, the indicator or the index of the transmission point is included in RRC signaling.

When transmission points each related to the priority of the type of channel state report are all identical, for example, when one periodic channel state report is the type 3 report for a PCC of the RRH and another periodic channel state report is the type 6 report for a SCC of the RRH, the channel state report transmission setter 703 may select a channel state report to be transmitted, based on which CC each periodic channel state report is related to, namely, based on a serving cell index ServCellIndex.

The serving cell index ServCellIndex may be determined through RRC signaling.

Case 2-5

The channel state report transmission setter 703 may select a channel state report to be transmitted, based on which CSI-RS resource each channel state report is about.

As in the above-described Case 1-1, priority between the transmission points may follow predetermined rules. Otherwise, the priority between the transmission points may be determined by an indicator (or an index of a transmission point) indicating which one of the multiple transmission points is related to a channel state report for which priority is to be set. Here, the indicator or the index of the transmission point is included in RRC signaling.

When periodic channel state reports related to an identical transmission point collide with each other, for example, when one periodic channel state report is a periodic channel state report for a PCC of the RRH and another periodic channel state report is a periodic channel state report for a SCC of the RRH, the channel state report transmission setter 703 may select a channel state report to be transmitted, based on the type of each periodic channel state report.

An example of priority according to the type of channel state report is shown in Table 4 above.

When related transmission points are all identical and priorities of types are all identical, for example, when one periodic channel state report is the type 3 report for a PCC of an RRH and another periodic channel state report is the type 6 report for a SCC of the same RRH, is the channel state report transmission setter 703 may select a channel state report to be transmitted, based on which CC each periodic channel state report is related to, namely, based on a serving cell index ServCellIndex.

The serving cell index ServCellIndex may be determined through RRC signaling.

The UE may select a periodic channel state report to be transmitted, by using one of Cases 1-1 to 2-5 as predetermined rules.

Otherwise, the UE may select a periodic channel state report to be transmitted, by using one of Cases 1-1 to 2-5 that the BS has designated. The BS generates information indicating an order in which one or more of priority according to the type of periodic channel state report, priority according to CSI-RS resources and priority according to a CC are to be applied. The BS transmits indication information through RRC signaling or a PDCCH, and thereby can indicate a scheme in which the UE selects a periodic channel state report to be transmitted.

In order to increase the efficiency of transmitting downlink data to the UE, use may be made of a CoMP technology in which the multiple transmission points cooperate with each other, and the CA technology for aggregating multiple CCs. When the CoMP technology is used, there may exist a transmission point which is more efficient among the multiple transmission points, and a periodic channel state report related to the more efficient transmission point may have priority. When the CA technology is used, there may exist a CC which is more is efficient among multiple CCs, and a periodic channel state report related to the more efficient CC may have priority.

Meanwhile, periodic channel state reports are classified into various types. A channel state report of a type which has a long transmission period and affects another type among the various types may have priority. As compared with feedback for a subband, feedback for wideband may have priority.

Meanwhile, when a periodic channel state report is transmitted in an uplink subframe in which uplink data exists, periodic channel state reports on all of the transmission points can be multiplexed with an uplink PUSCH.

At this time, the order of periodic channel state reports may comply with various methods. For example, channel state reports on activated carriers of the BS may be arranged in the order of increasing ServCellIndex values. Next, channel state reports on activated carriers of the RRH may be arranged in the order of increasing ServCellIndex values.

In the above-described embodiments of the present invention, a case has been described in which a channel state report to be transmitted is selected by sequentially applying priority according to the type of channel state report, priority according to a related transmission point and priority according to a related CC. However, embodiments of the present invention are not limited thereto. For example, priority may be determined by combining the type of channel state report, a transmission point, a CC and the like.

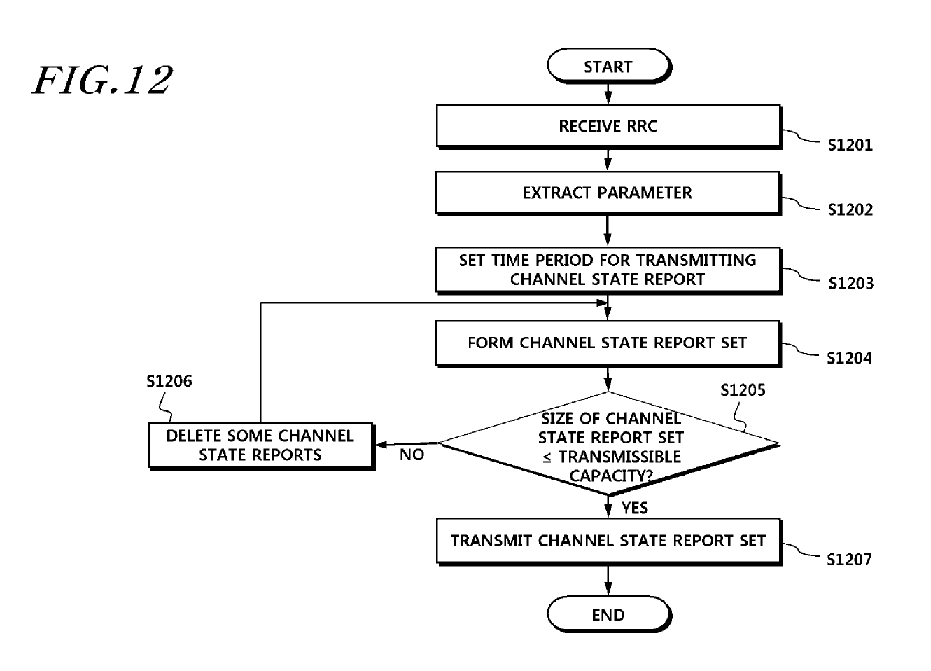

FIG. 12 is a flowchart illustrating a method for periodically reporting a channel state by the apparatus 700 for the channel state report as illustrated in FIG. 7, according to still another embodiment of the present invention.

In FIG. 12, steps S1201 to S1203 are identical to steps S1101 to S1103 as illustrated in FIG. 11, and thus a detailed description thereof will be omitted.

In step S1204, the channel state report transmission setter 703 forms one channel state report set by combining multiple channel state reports.

When the UE receives a downlink signal from each of the multiple transmission points, a channel state report set may be obtained by combining channel state reports on the multiple transmission points. When the UE receives downlink signals from the multiple transmission points through multiple CCs, a channel state report set may be obtained by combining channel state reports on the multiple CCs with channel state reports on the multiple transmission points.

When the UE communicates with the multiple transmission points, the order of channel state reports in a channel state report set may be set similarly to a scheme in which the priority has been set in Cases 1-1 or 1-2 (refer to Table 3).

Specifically, the order of channel state reports may follow,

(1-1) priority which is based on CSI-RS resources (a transmission point), or

(1-2) 1. priority which is based on the type of channel state report, and 2. priority is which is based on CSI-RS resources.

When the UE communicates with the multiple transmission points through multiple CCs, the order of channel state reports in a channel state report set may be set similarly to a scheme in which the priority has been set in one of Cases 2-1 to 2-5 (refer to Table 5).

In other words, the order of channel state reports may follow,

(2-1) 1. priority which is based on a serving cell index, and 2. priority which is based on CSI-RS resources,

(2-2) 1. priority which is based on CSI-RS resources, and 2. priority which is based on a serving cell index,

(2-3) 1. priority which is based on the type of channel state report, 2. priority which is based on a serving cell index, and 3. priority which is based on CSI-RS resources,

(2-4) 1. priority which is based on the type of channel state report, 2. priority which is based on CSI-RS resources, and 3. priority which is based on a serving cell index, or

(2-5) 1. priority which is based on CSI-RS resources, 2. priority which is based on the type of channel state report, and 3. priority which is based on a serving cell index.

A channel state report set may be transmitted by using a PUCCH format 3. Maximum transmissible capacity (i.e., the number of encoded bits) of the PUCCH format 3 may be limited (e.g., 22 bit).

In step S1205, the channel state report transmission setter 703 determines whether is the size of a channel state report set is less than transmissible capacity (e.g., 22 bits). When the size of the channel state report set exceeds the transmissible capacity (No in step S1205), the channel state report transmission setter 703 deletes some channel state reports from the channel state report set, in step S1206. The deletion process may be repeated until the size of the channel state report set is less than or equal to the transmissible capacity.

In an example, a channel state report may be deleted in the order of lower priority which is set in the scheme of one of the above-described Cases 1-1 to 2-5, from among channel state reports included in the channel state report set. The deletion of a channel state report may be performed until the size of the channel state report set which remains after deletion of a channel state report is less than or equal to the transmissible capacity.

In another example, a channel state report to be deleted from the channel state report set may be selected in view of the size of each channel state report.

When one channel state report is deleted and thereby the overall size of the channel state report set is less than or equal to the transmissible capacity, the channel state report may be deleted. For example, when maximum transmissible capacity is equal to 22 bits and channel state reports respectively have sizes of 16 bits, 8 bits and 8 bits, if the 16-bit channel state report is deleted, the total number of bits of channel state reports to be transmitted is less than or equal to 22 bits. Accordingly, the 16-bit channel state report may be deleted.

When the overall size of the channel state report set which remains after deletion is of any channel state report exceeds the transmissible capacity, a channel state report may be deleted in the order of the size of a channel state report. Accordingly, as many channel state reports as possible can be transmitted.

Referring again to FIG. 12, when the size of the channel state report set is less than or equal to the transmissible capacity (Yes in step S1205), the uplink transmitter 705 transmits the channel state report set by using the PUCCH format 3, in step S1207. As described above, when the channel state report set includes multiple periodic channel state reports and the overall size of periodic channel state reports exceeds the size of the PUCCH format 3, some periodic channel state reports may be deleted from the channel state report set.

The above description is only an illustrative description of the technical idea of the present invention, and those having ordinary knowledge in the technical field, to which the present invention pertains, will appreciate that various changes and modifications may be made to the embodiments described herein without departing from the essential features of the present invention. Therefore, the embodiments disclosed in the present invention are intended not to limit but to describe the technical idea of the present invention, and thus do not limit the scope of the technical idea of the present invention. The protection scope of the present invention should be construed based on the appended claims, and all of the technical ideas included within the scope equivalent to the appended claims should be construed as being included within the right scope of the present invention.

1. A method for providing a setting of a periodic channel state report by a base station, the method comprising:
setting multiple transmission points in a Coordinated Multi-Point Tx/Rx Communication System (CoMP) environment;
generating multiple parameters determining a period and an offset for a periodic channel state report on each of the multiple transmission points; and
transmitting the multiple parameters to a user equipment,
wherein the multiple parameters comprise:
a parameter determining a period and an offset for a Channel Quality Indicator/Precoding Matrix Indicator (CQI/PMI) report; and
a parameter determining a period and an offset for a Rank Indication (RI) report.

2. The method as claimed in claim 1, further comprising setting an index of a transmission point that determines transmission priority when periodic channel state reports on different transmission points collide with each other, and
wherein the transmitting of the multiple parameters comprise transmitting the index of the transmission point.

3. The method as claimed in claim 1, further comprising generating information indicating an order in which one or more of priority that is based on a transmission point and priority that is based on a type of periodic channel state report are to be applied, when periodic channel state reports on different transmission points collide with each other, and
wherein the transmitting of the multiple parameters further comprises transmitting the indication information.

4. A method for providing a setting of a periodic channel state report by a base station, the method comprising:
setting multiple transmission points in a Coordinated Multi-Point Tx/Rx Communication System (CoMP) environment and one or more component carriers, through which downlink data is to be transmitted by each of the multiple transmission points in a Carrier Aggregation (CA) environment;
generating multiple parameters determining periods and offsets for periodic channel state reports on the one or more component carriers, by the multiple transmission points; and
transmitting the multiple parameters to a user equipment,
wherein the multiple parameters comprise:
a parameter determining a period and an offset for a Channel Quality Indicator/Precoding Matrix Indicator (CQI/PMI) report; and
a parameter determining a period and an offset for a Rank Indication (RI) report.

5. The method as claimed in claim 4, further comprising setting an index of a transmission point that determines transmission priority when periodic channel state reports on different transmission points collide with each other, or an index of a component carrier that determines transmission priority when periodic channel state reports on different component carriers collide with each other, and
wherein the transmitting of the multiple parameters comprise transmitting the index of the transmission point or the index of the component carrier.

6. The method as claimed in claim 4, further comprising generating information indicating an order in which one or more of priority that is based on a transmission point, priority that is based on a component carrier and priority that is based on a type of periodic channel state report are to be applied when periodic channel state reports on different transmission points collide with each other, and
wherein the transmitting of the multiple parameters further comprises transmitting the indication information.

7. A method for providing a periodic channel state report by an user equipment, the method comprising:
extracting multiple parameters determining a period and an offset for a periodic channel state report on each of multiple transmission points in a Coordinated Multi-Point Tx/Rx Communication System (CoMP) environment;
setting a transmission time period, during which the periodic channel state report on each of the multiple transmission points is to be transmitted, by using the multiple parameters; and
transmitting a periodic channel state report on a transmission point matched to the transmission time period through a Physical Uplink Control Channel (PUCCH),
wherein the multiple parameters comprise:
a parameter determining a period and an offset for a Channel Quality Indicator/Precoding Matrix Indicator (CQI/PMI) report; and
a parameter determining a period and an offset for a Rank Indication (RI) report.

8. The method as claimed in claim 7, further comprising selecting a periodic channel state report to be transmitted, based on priority according to a transmission point or priority according to a type of periodic channel state report, when multiple periodic channel state reports are set to be simultaneously transmitted.

9. The method as claimed in claim 7, wherein a channel state report set obtained by combining multiple periodic channel state reports is transmitted through the PUCCH, when the multiple periodic channel state reports are set to be simultaneously transmitted.

10. The method as claimed in claim 9, wherein
a periodic channel state report included in the channel state report set is selected based on priority according to a transmission point, priority according to a type of periodic channel state report, or a size of a periodic channel state report, so as to cause a size of the channel state report set to be less than or equal to capacity of the PUCCH.

11. The method as claimed in claim 7, wherein the extracting of the multiple parameters further comprises extracting an indicator or an index of a transmission point that determines priority of channel state reports on different transmission points.

12. A method for providing a periodic channel state report by an user equipment, the method comprising:
extracting multiple parameters determining periods and offsets for periodic channel state reports on one or more component carriers of multiple transmission points, from a received downlink signal;
setting a transmission time period, during which the periodic channel state reports on the one or more component carriers of the multiple transmission points are to be transmitted, by using the multiple parameters; and
transmitting a periodic channel state report on a component carrier of a transmission point matched to the transmission time period through a Physical Uplink Control Channel (PUCCH),
wherein the multiple parameters comprise:
a parameter determining a period and an offset for a Channel Quality Indicator/Precoding Matrix Indicator (CQI/PMI) report; and
is a parameter determining a period and an offset for a Rank Indication (RI) report.

13. The method as claimed in claim 12, further comprising selecting a periodic channel state report to be transmitted, based on an index of a component carrier, priority according to a transmission point, or priority according to the type of periodic channel state report, when it is determined that multiple periodic channel state reports collide with each other.

14. The method as claimed in claim 12, wherein a channel state report set obtained by combining multiple periodic channel state reports is transmitted through the PUCCH, when the multiple periodic channel state reports are set to be simultaneously transmitted.

15. The method as claimed in claim 14, wherein a periodic channel state report included in the channel state report set is selected based on an index of a component carrier, priority according to a transmission point, priority according to a type of periodic channel state report, or a size of a periodic channel state report, so as to cause a size of the channel state report set to be less than or equal to capacity of the PUCCH.

16. The method as claimed in claim 12, wherein the extracting of the multiple parameters further comprises extracting an indicator or an index of a transmission point that determines priority of channel state reports on different transmission points.
